(19) United States
(12) Patent Application Publication
(10) Pub. No.: US 2016/0356434 A1
(43) Pub. Date: Dec. 8, 2016

(54) LIGHT MIXING STRUCTURE

(71) Applicant: ISUZU OPTICS CORP., Zhubei City (TW)

(72) Inventor: CHIH-HSUAN TSUEI, Zhubei City (TW)

(73) Assignee: ISUZU OPTICS CORP., Zhubei City (TW)

(21) Appl. No.: 14/728,548

(22) Filed: Jun. 2, 2015

(51) Int. Cl. F21K 99/00; F21V 3/04

(52) U.S. Cl. CPC F21K 9/54; F21V 3/049; F21Y 2101/02; F21Y 2113/00

(57) ABSTRACT

A light mixing structure includes a main body, a first light source, and a second light source. A first light path and a second light path are formed inside the main body, and communicate with each other. The first light source emits a first light beam toward the first light path, while the second light source emits a second light beam toward the second light path. The first and the second light beams emitted by the first light source and the second light source respectively and separately enter the first light path and the second light path, and are not mixed until the first light path and the second light path are merged in a rear section of the main body. Whereby, the problem of degrading components in the light sources due to exposure to the light emitted by the other light source can be prevented.

### BACKGROUND OF THE INVENTION

### 1. Technical Field

The present invention relates generally to light mixing, and more particularly to a light mixing structure which can be considered as an adjustable light source capable of emitting multi-wavelength, nearly full spectrum light.

### 2. Description of Related Art

Monochromatic light sources which emit red light, green light, and blue light are typically used as basic light sources for mixing light. In response to different requirements, the intensity of light emitted from each basic light source can be adjusted to perform additive or subtractive color mixture process to generate light of different colors.

However, in the domain of optical measurement, while measuring the radiated power and luminous flux of a light source with integrating sphere, the spectral range of the light source is required to cover the full spectrum from ultraviolet light, visible light, to invisible light. Take another example, in the domain of optical detection, a light source is required to emit light of a specific wavelength to detect specific fluorescent materials while making nondestructive fluorescence detections, and most of fluorescent materials can be only excited by ultraviolet light. Therefore, it is beyond doubt that ultraviolet light is indispensable in these situations.

In this sense, mixing light by merely using light sources of red light, green light, and blue light has obvious physical limitation on wave band, and is unable to generate light of all required wavelengths. Apparently, such technique is becoming insufficient to satisfy current demands. The basic light sources for mixing light must include light sources that are capable of emitting ultraviolet light and visible light to provide light of a wider range of the spectrum to meet specific requirements.

Unfortunately, when light sources of ultraviolet light and visible light are provided together, the package structure and crystal grains of the light source of visible light tend to be degraded and oxidized due to long term ultraviolet exposure, which not only decreases the light emitting efficiency of the light source of visible light, but also shortens its life. How to prevent such adverse effects is a problem yet to be solved.

### BRIEF SUMMARY OF THE INVENTION

In view of the above, the primary objective of the present invention is to provide a light mixing structure which can be considered as an adjustable light source capable of emitting multi-wavelength, nearly full spectrum light, wherein the light mixing structure is able to ease negative effects caused among different light sources when being applied to mix light with at least two light sources.

The present invention provides a light mixing structure, which includes a main body, a first light source, and a second light source. A first light path and a second light path are formed inside the main body; the first light path has a first inlet and a first outlet formed on a surface of the main body; the second light path has a second inlet formed on a surface of the main body; the second light path and the first light path communicate with each other. The first light source emits a first light beam, wherein the first light beam enters the first inlet of the first light path, and leaves the main body through the first outlet. The second light source emits a second light beam, wherein the second light beam enters the second inlet of the second light path, and also leaves the main body through the first outlet.

With the aforementioned design, the first light beam and the second light beam emitted from the first light source and the second light source respectively and separately enter the first light path and the second light path of the main body without being mixed until the first light path and the second light path are merged in the rear section of the main body, and then the mixed first and second light beams leave the main body together. In this way, the problem of being degraded due to direct exposure to the light emitted from the other light source can be prevented.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the main body of the light mixing structure provided in the present invention;

FIG. 2 is a sectional view along the 2-2 line in FIG. 1;

FIG. 3 is a sectional view along the 3-3 line in FIG. 1;

FIG. 4 is a schematic diagram, showing the light mixing structure provided in the present invention being applied in practice; and

FIG. 5 is a schematic diagram of the light mixing structure provided in the present invention, showing an optical filter disposed on the first light source.

### DETAILED DESCRIPTION OF THE INVENTION

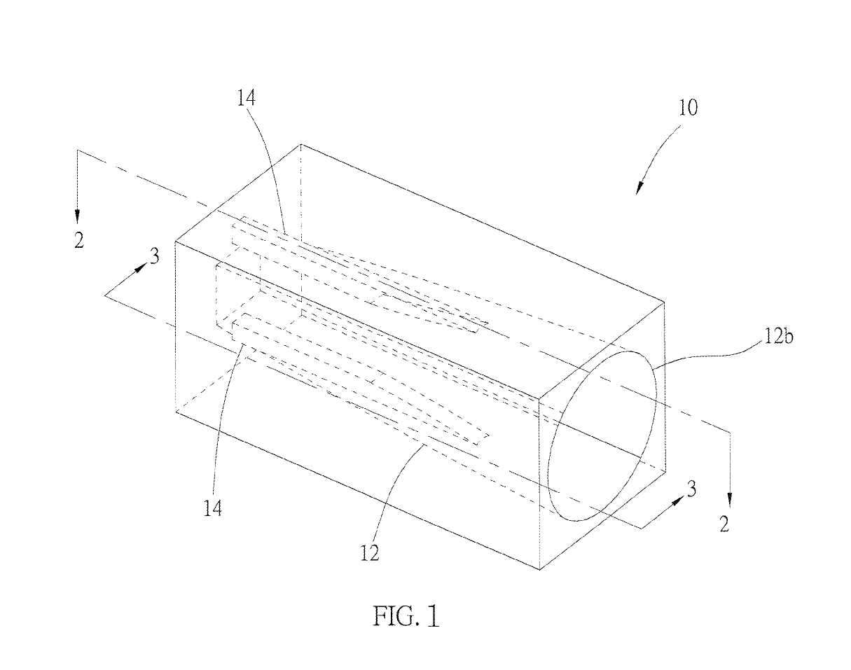

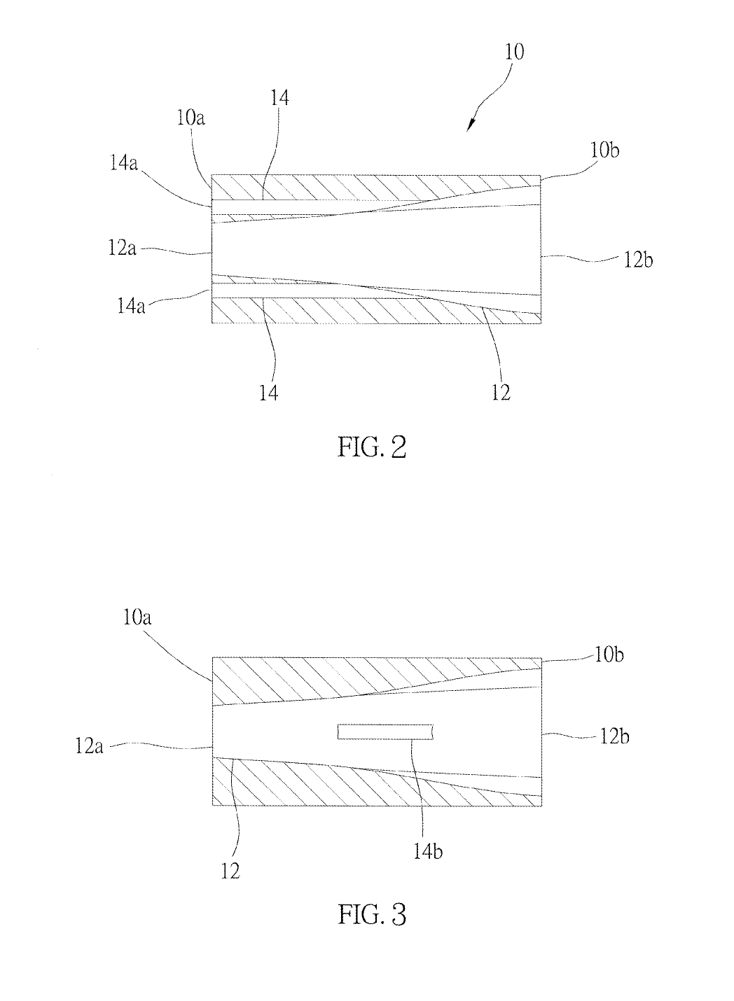

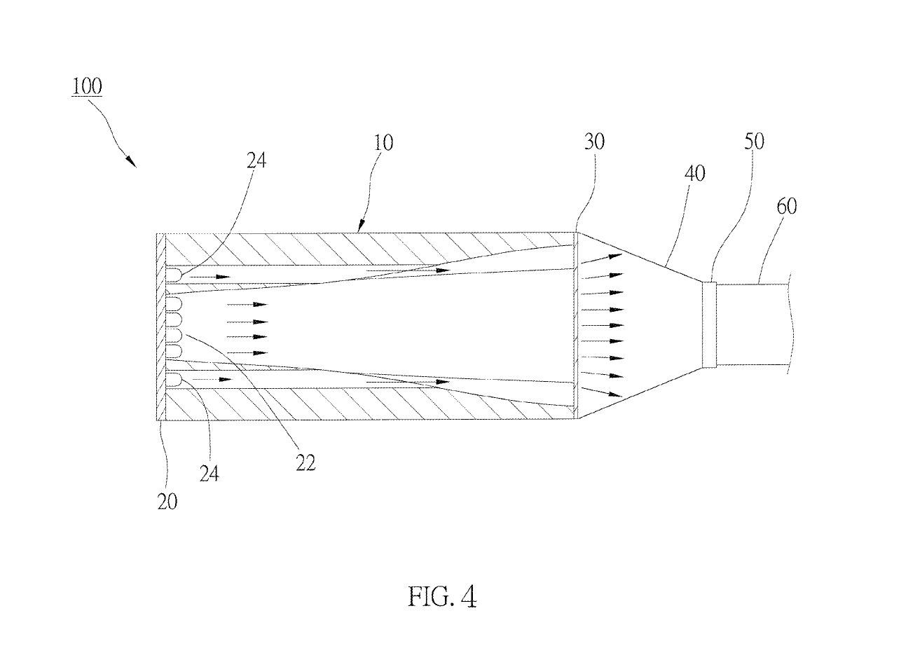

As shown in FIG. 1 to FIG. 4, a light mixing structure of a preferred embodiment includes a main body 10, a circuit board 20, a light-diffusing member 30, a coupling member 40, an optical shutter 50, and a light-guiding member 60.

The main body 10 has two opposite surfaces, which are a front surface 10a and a rear surface 10b respectively. A first light path 12 and two second light paths 14 are formed inside the main body 10, wherein the first light path 12 has a first inlet 12a formed on the front surface 10a of the main body 10, and a first outlet 12b formed on the rear surface 10b of the main body 10. The first light path 12 gradually expands from the first inlet 12a towards the first outlet 12b. Each of the two second light path 14 has a second inlet 14a formed on the front surface 10a of the main body 10 respectively, and communicates to the first light path 14 to form a second outlet 14b on an inner wall of the first light path 12 inside the main body 10.

The circuit board 20 is disposed on the front surface 10a of the main body 10, and has a first light source 22 and two second light sources 24 thereon. The first light source 22 includes a plurality of visible light LEDs (light-emitting diode), each of which emits a visible first light beam of different wavelengths. The first light beams enter the first inlet 12a of the first light path 12, and leave the main body 10 through the first outlet 12b. Each of the second light sources 24 respectively includes an invisible light LED to emit an invisible second light beam. The visible light LEDs and the invisible light LEDs can be controlled to provide different intensities and flicker frequencies.

The light-diffusing member 30 is disposed on the rear surface 10b of the main body 10 which has the first outlet 12b formed thereon, wherein the light-diffusing member 30 makes the first light beams and the second light beams going out from the first outlet 12b evenly diffuse to create the effect of diffusion and scattering, which contributes to evenly mix the first light beams and the second light beams. The light-diffusing member 30 can be a diffusion plate, a diffusion film, or a transparent substrate coated with an optical film which contributes to diffuse light.

The coupling member 40 is connected to the light-diffusing member 30, wherein the coupling member 40 provides the function of condensing light. The diffused first and second light beams which pass through the light-diffusing member 30 are collected by the coupling member 40 to generate a light beam with more concentrated energy.

The optical shutter 50 is disposed between the coupling member 40 and the light-guiding member 60, wherein the optical shutter 50 adjusts the amount of light transmitted from the coupling member 40 to the light-guiding member 60.

The light-guiding member 60 guides and transmits the light beam condensed by the coupling member 40 to be used by a user. The light-guiding member 60 can be an optical waveguide, a light pipe, or an optical fiber.

With the aforementioned design, the first and the second light beams emitted by the first light source 22 and the second light source 24 respectively and separately enters the first light path 12 and the second light paths 14 of the main body 10, and are not mixed until the second light beams pass through one of the second outlets 14b and enter the first light path. In this way, the first light source 22 and second light source 24 are prevented from being exposed to the light emitted by each other. As a result, the invisible second light beams are prevented from directly or indirectly casting on the visible light LEDs of the first light source 22, and therefore the problem of degrading or oxidizing the package structure and crystal grains of the visible light LEDs due to exposure to invisible light can be further eased.

Furthermore, the LEDs of the first light source 22 and the second light source 24 can be analog controlled or digitally regulated to control the light emission thereof, and to provide different flicker frequencies and illuminances. In this sense, the light mixing structure can be considered as an adjustable light source 100 capable of emitting multi-wavelength, nearly full spectrum light, and therefor is especially suitable to be applied in situations which require a light source to cover the visible and invisible wave bands.

In order to prevent the energy of light from being absorbed by the main body 10 while passing therethrough, the main body 10 can be made of materials having high reflectivity. Alternatively, inner walls of the first light path 12 and the second light paths 14 can be coated with a reflective film to reduce energy loss while light beams passing through the first light path 12 and the second light path 14.

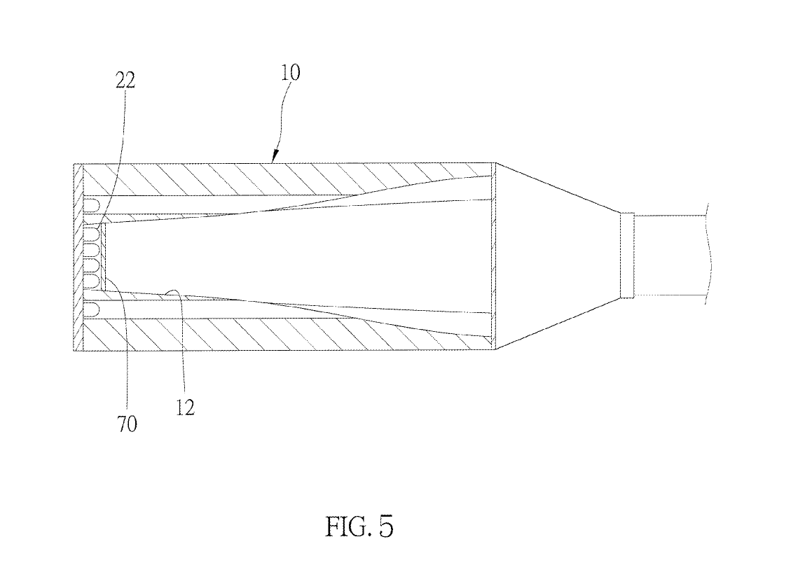

It is worth mentioning that, the second light beams may be still possible to reach the first light source 22 located at first inlet 12a after passing through one of the second outlets 14b through several reflections. As shown in FIG. 5, the main body 10 can further include an optical filter 70 disposed on the first light source 22 in another embodiment, wherein the optical filter 70 only allows visible light to pass through, but filters out invisible light. Therefore, the invisible second light beams can be prevented from casting on the visible light LEDs of the first light source 22.

In the aforementioned embodiments, the first inlet 12a of the first light path 12 and the second inlets 14a of the second light paths 14 are formed on the front surface 10a of the main body 10. In other words, the first inlet 12a and the second inlets 14a are all formed on the same surface of the main body 10. In this way, the light mixing structure provided in the present invention needs only one circuit board 20. In other embodiments, the inlets of the first light path and the second light paths can be formed on different surfaces of the main body 10.

In addition, the wave bands of the light emitted by the first light source 22 and the second light source 24 can be exchanged to meet different requirements. In other words, the first light beams emitted by the first light source 22 can be invisible instead, while the second light beams emitted by the second light source 24 can be visible at the same time.

It must be pointed out that the embodiments described above are only some preferred embodiments of the present invention. All equivalent structures which employ the concepts disclosed in this specification and the appended claims should fall within the scope of the present invention.

What is claimed is:

1. A light mixing structure comprising:
a main body, wherein a first light path and a second light path are formed inside the main body; the first light path has a first inlet and a first outlet formed on a surface of the main body; the second light path has a second inlet formed on a surface of the main body; the second light path and the first light path communicate with each other;
a first light source emitting a first light beam, wherein the first light beam enters the first inlet of the first light path, and leaves the main body through the first outlet; and
a second light source, emitting a second light beam, wherein the second light beam enters the second inlet of the second light path, and also leaves the main body through the first outlet.

2. The light mixing structure of claim 1, wherein the first light beam emitted by the first light source is visible; the second light beam emitted by the second light source is invisible.

3. The light mixing structure of claim 2, wherein the first light source comprises a plurality of visible light LEDs, each of which respectively emits light of different wavelengths; the second light source comprises an invisible light LED to emit the second light beam.

4. The light mixing structure of claim 2, further comprising an optical filter disposed on the first light source to prevent the second light beam from casting on the first light source.

5. The light mixing structure of claim 1, wherein the first light beam emitted by the first light source is invisible; the second light beam emitted by the second light source is visible.

6. The light mixing structure of claim 1, wherein the first inlet of the first light path and the second inlet of the second light path are formed on the same surface of the main body.

7. The light mixing structure of claim 1, wherein the first light path gradually expands from the first inlet towards the first outlet.

8. The light mixing structure of claim 1, further comprising a light-diffusing member disposed on the surface of the main body having the first outlet formed thereon, wherein the light-diffusing member diffuses the first light beam and the second light beam.

9. The light mixing structure of claim 8, further comprising a coupling member and a light-guiding member, wherein the coupling member is connected to the light-diffusing member to condense the first light beam and the second light beam diffused by the light-diffusing member; the light-guiding member is connected to the coupling member to guide the first and the second light beams condensed by the coupling member.

10. The light mixing structure of claim 9, further comprising an optical shutter disposed between the coupling member and the light-guiding member to adjust an amount of light transmitted from the coupling member to the light-guiding member.
